(19) United States
(12) Patent Application Publication
(10) Pub. No.: US 2026/0056449 A1
(43) Pub. Date: Feb. 26, 2026

(54) Foldable Camera Support Apparatus with Adjustable Angular Positioning and Stabilized Base

(71) Applicants: LATIFA ZERAOULA, BRETIGNY SUR ORGE (FR); SOFYAN SAKHRI, BRETIGNY SUR ORGE (FR)

(72) Inventors: LATIFA ZERAOULA, BRETIGNY SUR ORGE (FR); SOFYAN SAKHRI, BRETIGNY SUR ORGE (FR)

(21) Appl. No.: 18/811,000

(22) Filed: Aug. 21, 2024

(51) Int. Cl. G03B 17/56; F16M 11/04; F16M 11/12; F16M 11/20; F16M 11/38

(52) U.S. Cl. CPC G03B 17/561; F16M 11/041; F16M 11/126; F16M 11/2021; F16M 11/38; F16M 2200/024; F16M 2200/065; F16M 2200/068; F16M 2200/08

(57) ABSTRACT

The present invention relates to a camera support apparatus comprising a base assembly with a central hub and a plurality of pivotable leg members that transition between retracted and extended positions, forming a stable support base. A vertical support assembly extends from the base, consisting of multiple interconnected support sections joined by tensioned joints that allow angular adjustment and maintain position without manual locking. The apparatus also includes a top handle assembly with a camera mount, enabling manual adjustment of the camera's orientation. The entire apparatus is foldable into a compact configuration by collapsing the leg members and aligning the support sections. The camera support apparatus is designed to offer portability, ease of use, and stability, making it suitable for various photographic and videographic applications where quick setup, precise adjustment, and reliable support are required.

### FIELD OF INVENTION

The present invention relates to camera support systems, specifically to a foldable camera support apparatus designed for adjustable angular positioning and enhanced stability, suitable for use in photography and videography.

### BACKGROUND

In the field of photography and videography, the use of camera support systems, particularly tripods, has been indispensable for achieving stable and consistent shots. These tools have evolved significantly over time, adapting to the changing needs of professionals and enthusiasts alike. However, despite numerous advancements, traditional tripods still present several challenges, particularly in situations that require quick and frequent adjustments to camera angles. These limitations can significantly hinder the creative process, especially for video content creators who rely on dynamic shots to maintain viewer engagement.

Traditional tripods are often designed with a focus on stability and load-bearing capacity, but this comes at the cost of flexibility and ease of use. Adjusting the camera angle or position typically involves manipulating several knobs, levers, or screws, which can be time-consuming and cumbersome. This complexity becomes especially problematic in fast-paced shooting environments where capturing the perfect shot quickly is crucial. The need to manually adjust multiple components can interrupt the flow of shooting, leading to missed opportunities and reduced efficiency.

Furthermore, traditional tripods generally lack the ability to make rapid and precise angle adjustments without sacrificing stability. The mechanisms used in conventional designs often require the operator to loosen and tighten various parts, which not only takes time but can also introduce instability during the adjustment process. This can be particularly frustrating when attempting to capture precise shots, as the camera may shift or wobble, leading to blurred images or footage. Additionally, the effort required to make these adjustments can be physically demanding, especially during prolonged shooting sessions, contributing to user fatigue.

Another significant limitation of traditional tripod designs is their inability to easily accommodate a wide range of shooting angles, particularly low-angle or high-angle shots. Many tripods are optimized for standard or eye-level shooting positions, and adjusting them to capture unconventional angles often involves intricate reconfiguration. This can involve repositioning the legs, adjusting the height, and manipulating the head of the tripod, all of which can be cumbersome and time-consuming. In creative content production, where variety and experimentation with different perspectives are essential, these constraints can severely limit the scope of what can be achieved.

Moreover, the portability and ease of transport of traditional tripods are often compromised by their design. Many tripods are bulky and heavy, making them less than ideal for content creators who need to move quickly between locations or frequently change setups. While some models are designed to be more compact, they often sacrifice stability or durability, which can be problematic in professional settings. The need for a tripod that balances portability with robustness and versatility has become increasingly apparent as content creators continue to push the boundaries of their craft.

In addition to these physical and mechanical limitations, traditional tripods also struggle to keep up with the demands of modern content creation workflows. The rise of social media platforms and the increasing importance of video content in digital marketing have created a need for tools that can facilitate rapid, on-the-go shooting. Content creators often work under tight deadlines and in varying environments, requiring equipment that can adapt quickly and perform reliably. The inability of conventional tripods to meet these needs can result in lost time, reduced productivity, and ultimately, lower-quality content.

These persistent challenges highlight the need for innovation in camera support systems. A solution that addresses the limitations of traditional tripods—providing ease of use, flexibility, and stability in one package—would significantly enhance the capabilities of video content creators. By enabling quick and effortless adjustments to camera angles, such a solution would not only improve the efficiency of the shooting process but also open up new creative possibilities. The development of a tripod that can integrate into the fast-paced and demanding world of modern content creation is thus not just desirable but essential.

It is within this context that the present invention is provided.

### SUMMARY

The present invention provides a camera support apparatus designed to offer flexibility and stability while maintaining ease of use and portability. The apparatus comprises a base assembly with a central hub and a plurality of leg members that pivot between retracted and extended positions, forming a stable support base when deployed. A vertical support assembly extends from the base assembly and consists of multiple interconnected support sections connected by tensioned joints. These joints allow for angular adjustment of the support sections without requiring manual locking, and they maintain the set positions reliably. The apparatus further includes a top handle assembly at the uppermost section, featuring a camera mount that permits manual adjustment of the camera's orientation.

The camera support apparatus is foldable into a compact configuration by collapsing the leg members and aligning the support sections, making it convenient for transport and storage. This design provides a balance between portability and structural integrity, making it suitable for a range of professional and amateur videography and photography applications.

In some embodiments, the central hub of the base assembly includes a sliding mechanism that allows the leg members to move between their retracted and extended positions by sliding along a central axis. This feature facilitates quick setup and takedown of the apparatus, saving time and effort for the user.

In further embodiments, the leg members of the base assembly include locking mechanisms that secure them in the extended position, providing additional stability and preventing accidental movement during use. This ensures that the apparatus remains firmly in place, even on uneven surfaces or during dynamic camera movements.

In yet further embodiments, the leg members are equipped with vibration-damping foot assemblies made from hard plastic. These foot assemblies help to minimize vibrations transmitted from the ground to the apparatus, contributing to steadier shots and better overall performance.

In some embodiments, the tensioned joints within the vertical support assembly are configured as knobless joints that automatically maintain the angular positions of the support sections through internal tension. This design eliminates the need for external locking components, allowing for smoother and quicker adjustments.

In further embodiments, each tensioned joint incorporates a flexing mechanism that allows for smooth, incremental angular adjustments while providing resistance to inadvertent changes in position. This feature ensures precise control over the camera's positioning without the risk of slippage.

In yet further embodiments, the vertical support assembly is designed to fold down such that the support sections align substantially parallel to one another in the compact configuration. This minimizes the overall length of the apparatus when folded, enhancing its portability.

In some embodiments, the top handle assembly includes a rotational mechanism that allows the camera mount to rotate about a vertical axis, enabling panoramic rotation of the camera. This feature expands the range of possible camera angles and movements, providing greater creative flexibility.

In yet further embodiments, the camera mount on the top handle assembly includes a standard ¼″-20 tripod screw with a large knob for manual tightening. This design allows for secure and straightforward attachment of the camera to the apparatus.

In some embodiments, the camera mount also features an integrated quick-release mechanism, allowing for rapid attachment and detachment of the camera. This feature is particularly useful for photographers and videographers who need to switch cameras or setups quickly.

In further embodiments, the base assembly includes a cross-support strut assembly that connects the leg members to provide additional stability when they are in the extended position. This enhances the overall rigidity of the apparatus, particularly during extended use or in challenging conditions.

In yet further embodiments, the cross-support strut assembly is designed to automatically deploy as the leg members are extended and retract when the leg members are moved to the retracted position. This automation simplifies the setup process and ensures consistent performance.

In some embodiments, the vertical support assembly is height adjustable, with a minimum height of approximately 56 cm and a maximum height of approximately 158 cm. This range of height adjustment accommodates various shooting requirements, from low-angle to high-angle shots.

In further embodiments, the entire apparatus is constructed from aluminum for lightweight strength and durability, with select components made from hard plastic for vibration damping and user comfort. This material choice balances the need for a robust structure with the practical considerations of weight and ease of handling.

### BRIEF DESCRIPTION OF THE DRAWINGS

Various embodiments of the invention are disclosed in the following detailed description and accompanying drawings.

FIG. 1 illustrates an example of the camera support apparatus in an extended configuration, showing the overall structure.

FIG. 2 illustrates an example of a top-down view of the camera support apparatus, highlighting the top handle assembly and camera mount.

FIG. 3 illustrates an example of a bottom perspective view of the camera support apparatus, focusing on the underside of the top handle assembly and the quick-release mechanism.

FIG. 4 illustrates an example of a side view of the camera support apparatus, depicting the vertical support assembly in its extended state.

FIG. 5 illustrates an example of the camera support apparatus in a fully folded configuration, showing its compact form.

FIG. 6 illustrates an example of the central hub and leg members of the camera support apparatus, with an inset detail of the cross-support struts and joint mechanisms.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

When a feature or element is described as being “on” or “directly on” another feature or element, there may or may not be intervening features or elements present. Similarly, when a feature or element is described as being “connected,” “attached,” or “coupled” to another feature or element, there may or may not be intervening features or elements present. The features and elements described with respect to one embodiment can be applied to other embodiments.

The use of spatial terms, such as “under,” “below,” “lower,” “over,” “upper,” etc., is used for ease of explanation to describe the relationship between elements when the apparatus is in its proper orientation.

The terms “first,” “second,” and the like are used to distinguish different elements or features, but these elements or features should not be limited by these terms. A first element or feature described can be referred to as a second element or feature and vice versa without departing from the teachings of the present disclosure.

The term “base assembly” refers to the foundational structure of the camera support apparatus that provides stability and support for the entire device. This includes, but is not limited to, the central hub, leg members, and any associated mechanisms that enable the transition between retracted and extended positions. In one example implementation, the base assembly may be constructed from aluminum for lightweight strength, with leg members featuring hard plastic feet for vibration damping. The central hub may include a sliding mechanism that allows the leg members to pivot outward, forming a stable tripod base, and may be equipped with a locking mechanism to secure the legs in place during use.

The term “vertical support assembly” refers to the series of interconnected sections that extend upward from the base assembly to provide height and adjustable positioning for the camera mount. This includes, but is not limited to, support sections, tensioned joints, and any structural elements that facilitate the folding and unfolding of the apparatus. In one example implementation, the vertical support assembly may be composed of multiple aluminum sections, each connected by knobless tensioned joints that maintain a set angular position without manual locking. The assembly may be designed to extend to a maximum height of approximately 158 cm and fold down to a compact form for ease of transport.

The term “tensioned joint” refers to a type of connector between two sections of the vertical support assembly that allows for angular adjustment and maintains the set angle through internal tension. This includes, but is not limited to, any hinge, flexing mechanism, or friction-based system that permits smooth, incremental adjustments without the need for external locking components. In one example implementation, the tensioned joint may utilize a spring-loaded mechanism that provides resistance during adjustment and locks the support sections in place once the desired angle is achieved.

The term “top handle assembly” refers to the uppermost component of the camera support apparatus that includes the camera mount and any associated mechanisms for adjusting the orientation of the camera. This includes, but is not limited to, the handle itself, the camera mount, and any rotational or quick-release mechanisms that facilitate camera positioning. In one example implementation, the top handle assembly may be equipped with a standard ¼″-20 tripod screw mount featuring a large knob for manual tightening. The assembly may also include a rotational mechanism to allow for smooth panoramic rotation of the camera mount.

The term “camera mount” refers to the portion of the top handle assembly that directly interfaces with and secures the camera to the apparatus. This includes, but is not limited to, the screw mount, quick-release mechanisms, and any other components that facilitate attachment and detachment of the camera. In one example implementation, the camera mount may include a quick-release plate that allows for rapid swapping of cameras without the need for re-threading the screw mount, enhancing the speed and efficiency of setup changes during shooting.

In some implementations, the base assembly may feature adjustable leg members that can be extended to varying lengths, accommodating uneven surfaces or providing additional height. These leg members may range in length from 20 cm to 60 cm in their extended position, and may include locking notches that secure the legs at specific lengths. Additionally, the materials used for the feet of the leg members may include high-density rubber or silicone to further reduce vibration and improve stability on slippery surfaces.

In another example, the tensioned joints within the vertical support assembly may be constructed using a combination of high-tensile steel springs and polymer friction pads, allowing for both durability and smooth operation. The range of angular adjustment provided by these joints may be between 0°and 180°, enabling the apparatus to be configured for both low-angle and overhead shots with minimal effort.

### Description of Drawings

The present invention pertains to a camera support apparatus designed to address the shortcomings of traditional tripods and camera mounts, particularly in environments where quick and frequent adjustments to camera positioning are essential. Conventional tripods, while effective in providing stability, often suffer from limitations in flexibility, portability, and ease of use. These limitations include cumbersome and time-consuming adjustments, difficulty in achieving precise angles, and bulkiness that hinders transport and rapid deployment.

The invention provides a solution to these issues by introducing a foldable camera support apparatus that combines stability with versatility and ease of use. The apparatus features a base assembly with pivotable leg members that can be quickly transitioned between retracted and extended positions, forming a stable foundation that can be rapidly deployed and collapsed. This base assembly allows for both secure support during use and compact storage when not in use, addressing the portability concerns of traditional tripods.

Extending from the base assembly is a vertical support assembly, which consists of multiple interconnected sections joined by tensioned joints. These tensioned joints are designed to allow smooth angular adjustments without the need for manual locking mechanisms, thus enabling quick changes in camera positioning with minimal effort. This feature overcomes the time-consuming nature of angle adjustments in prior art devices, making the apparatus particularly useful in dynamic shooting environments where rapid setup and reconfiguration are necessary.

The top handle assembly, located at the uppermost section of the vertical support assembly, provides an adjustable camera mount that facilitates precise control over the orientation of the camera. The mount can be rotated and positioned easily, further enhancing the flexibility of the apparatus. This addresses the need for precise and varied camera angles without requiring the operator to manually manipulate multiple components, as is often the case with conventional tripods.

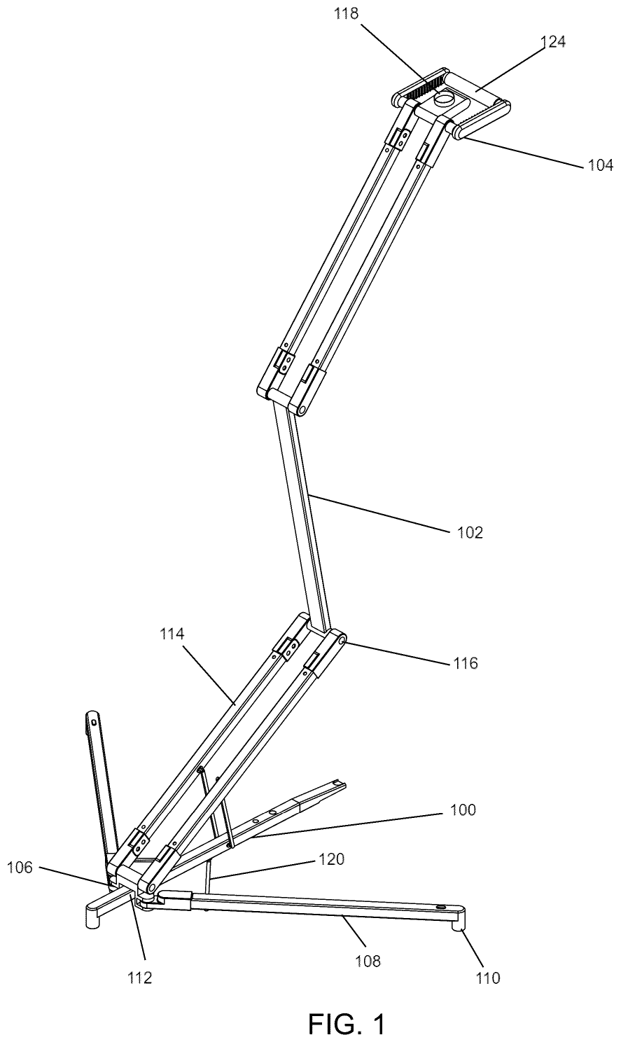

Referring now to the drawings, FIGS. 1-6 show an example implementation of the camera support apparatus of the present disclosure.

FIG. 1 illustrates a perspective view of the camera support apparatus in an extended configuration. The apparatus comprises a base assembly 100, a vertical support assembly 102, and a top handle assembly 104. The base assembly 100 includes a central hub 106, from which a plurality of leg members 108 extend. These leg members 108 are pivotably connected to the central hub 106 and are shown in their extended position, forming a stable support base for the apparatus. Each leg member 108 is equipped with a foot assembly 110 at its distal end, which includes hard plastic feet designed to provide vibration damping and stability.

The central hub 106 incorporates a sliding mechanism 112, which allows the leg members 108 to move between their retracted and extended positions. The leg members 108 are shown fully extended in this figure, with the sliding mechanism 112 locked in place to secure the base assembly 100 in a stable configuration. The leg members 108 may also include locking mechanisms, not specifically illustrated here, to prevent unintentional retraction during use.

The base assembly 100 further includes cross-support struts 120 that connect the leg members 108 to one another. These cross-support struts 120 are designed to enhance the overall stability of the camera support apparatus by preventing the leg members 108 from splaying outwards under the weight of the camera or during movement. The cross-support struts 120 are configured to automatically deploy as the leg members 108 are extended into their operational positions and retract when the leg members 108 are moved to the retracted configuration. This feature ensures that the tripod remains stable in a variety of positions, regardless of the surface or the angle of the vertical support assembly 102.

Extending upward from the base assembly 100 is the vertical support assembly 102, which consists of multiple interconnected support sections 114. Each support section 114 is joined to the adjacent support section by a tensioned joint 116. These tensioned joints 116 allow for angular adjustment of the support sections 114, enabling the apparatus to be configured at various angles to suit different shooting requirements. The tensioned joints 116 are designed to maintain their set positions without requiring manual locking, relying on internal tension to hold the support sections 114 in place.

The vertical support assembly 102 is shown in an extended configuration, with the support sections 114 aligned to create a continuous, linear structure. The apparatus can be folded into a compact form by pivoting the support sections 114 around the tensioned joints 116, aligning them substantially parallel to one another, and folding the leg members 108 into their retracted positions.

At the top of the vertical support assembly 102 is the top handle assembly 104, which includes a camera mount 118 and a handle grip 124 which may be rotatable with respect to the assembly. The top handle assembly 104 is connected to the uppermost support section 114 and is designed to allow for manual adjustment of the camera's orientation. The camera mount 118 features a standard ¼″-20 tripod screw, equipped with a large knob for easy manual tightening, allowing for secure attachment of the camera. The top handle assembly 104 may also include a rotational mechanism, which allows the camera mount 118 to rotate about a vertical axis, enabling panoramic shots.

The base assembly 100, vertical support assembly 102, and top handle assembly 104 are primarily constructed from aluminum, offering a balance of strength and lightweight characteristics. Select components, such as the foot assemblies 110 and the tensioned joints 116, may include materials such as hard plastic and high-tensile steel to enhance vibration damping, durability, and smooth operation. The apparatus is designed to extend to a maximum height of approximately 158 cm, providing versatility for both low-angle and overhead shots, while the compact, folded configuration allows for easy transport and storage.

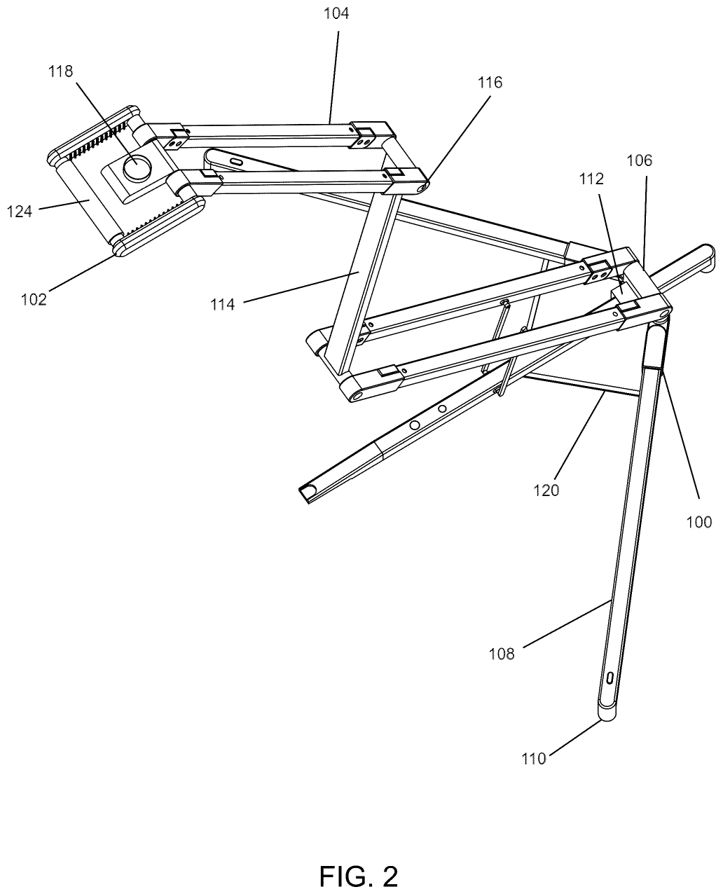

FIG. 2 provides a top-down view of the camera support apparatus, specifically focusing on the top handle assembly 104 and the camera mount 118. In this view, the arrangement and construction of the top handle assembly 104 are evident, showing the elongated handle sections that flank the central camera mount 118. The camera mount 118, centrally located within the top handle assembly 104, includes the standard ¼″-20 tripod screw and the large knob for manual tightening.

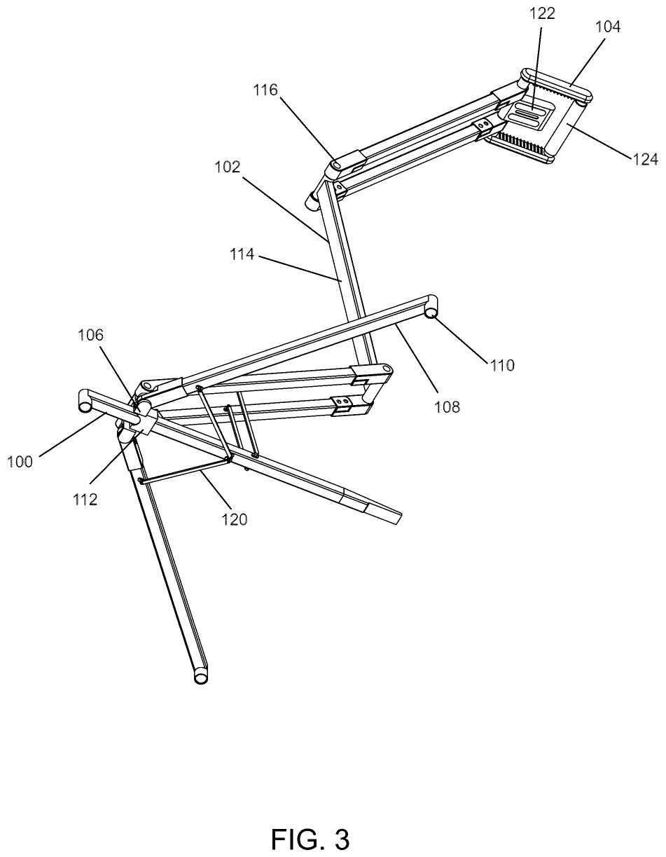

FIG. 3 offers a bottom perspective view of the top handle assembly 104, highlighting features not visible from the top or side views. Most notably, this figure illustrates the underside of the top handle assembly 104, where the openings 122 for the quick-release attachment point are located. These openings 122 form part of the quick-release mechanism designed to facilitate the rapid attachment and detachment of the camera from the apparatus. The openings 122 are structured to securely receive and engage the corresponding components of the detachable ¼″-20 camera mount.

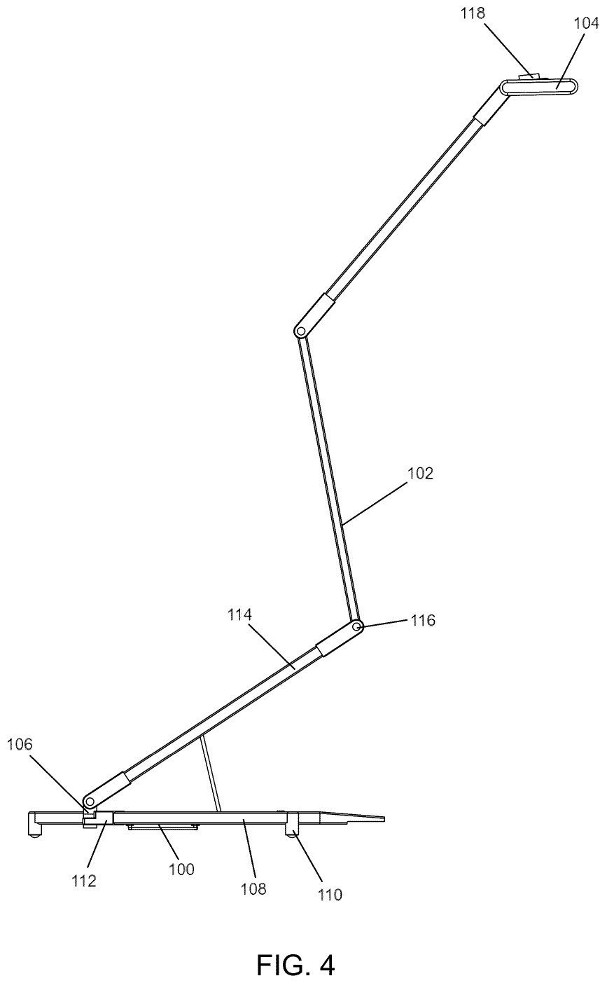

FIG. 4 presents a side view of the camera support apparatus. This view highlights the articulation points at the tensioned joints 116, providing insight into how the vertical support sections 114 pivot relative to each other. The side view also emphasizes the angular flexibility provided by the tensioned joints 116, allowing the apparatus to be configured in various positions while maintaining stability.

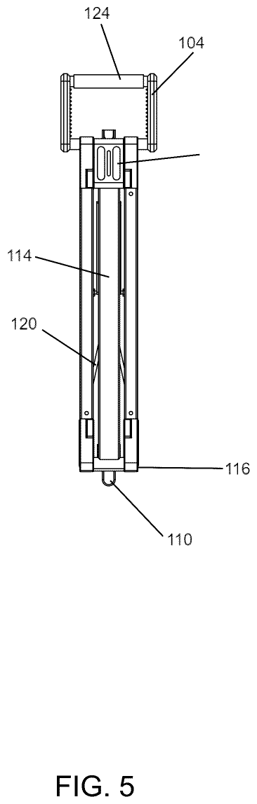

FIG. 5 illustrates the camera support apparatus in its fully folded configuration, highlighting the compact nature of the device when not in use. In this configuration, the apparatus is collapsed demonstrating its portability and ease of storage.

In this folded state, the leg members 108 of the base assembly 100 are fully retracted and aligned closely with the central hub 106, ensuring that the base assembly 100 forms a minimal profile. The sliding mechanism 112 within the central hub 106 has been engaged to draw the leg members 108 into their retracted positions, where they are aligned substantially parallel to each other and to the central axis of the vertical support assembly 102.

The vertical support assembly 102, consisting of the support sections 114 and tensioned joints 116, is also folded down. The support sections 114 are aligned in parallel, collapsing into a compact form that is directly in line with the leg members 108. The tensioned joints 116 allow this smooth transition into a folded configuration without the need for additional locking mechanisms, relying instead on the internal tension to hold the sections in place.

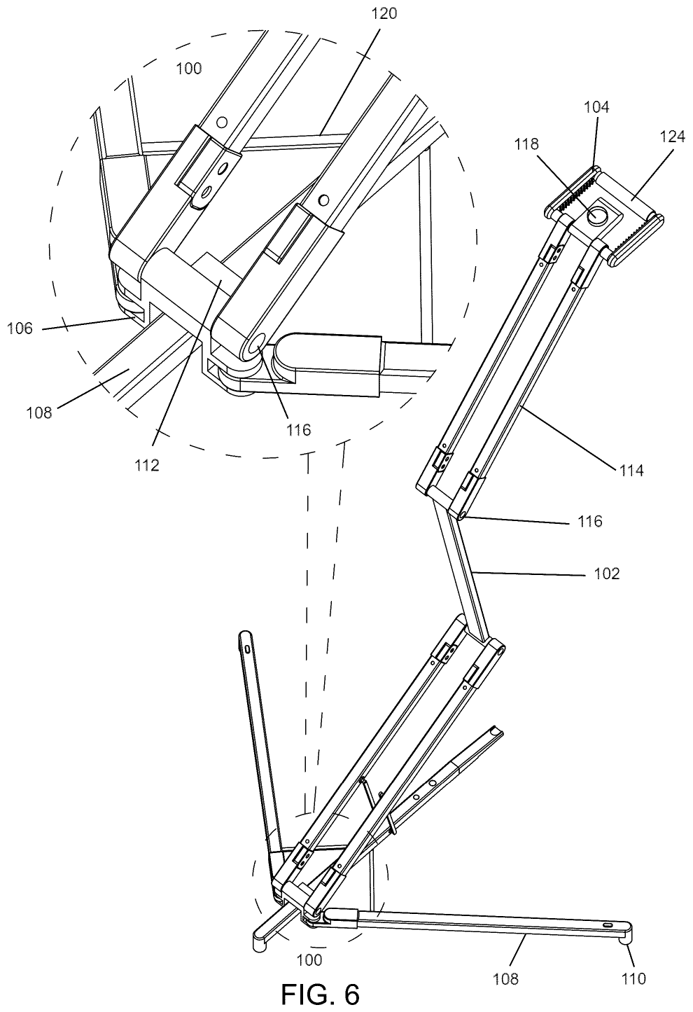

FIG. 6 provides a detailed perspective view of the camera support apparatus, focusing on the central hub 106 of the base assembly 100 and its associated mechanisms. This figure is accompanied by an enlarged inset that highlights the specific components within the central hub 106, particularly the connections between the leg members 108 and the central hub 106, as well as the role of the cross-support struts 120.

In this view, the central hub 106 is clearly depicted as the pivot point for the leg members 108. The leg members 108 are shown in an extended configuration, where they radiate outward from the central hub 106 to form a stable tripod base. The enlarged inset emphasizes the joint structures at the connection points between the leg members 108 and the central hub 106. These joints allow the leg members 108 to pivot smoothly between retracted and extended positions. The close-up view also reveals the sliding mechanism 112 integrated within the central hub 106, which facilitates the movement of the leg members 108 along the central axis. This mechanism enables the easy transition of the leg members 108 between their operational and storage configurations.

The cross-support struts 120 are also prominently featured in the inset. These struts extend between the leg members 108, providing additional lateral stability and preventing the legs from splaying out under load. The cross-support struts 120 are connected to the leg members 108 in such a way that they deploy automatically when the legs are moved to the extended position and retract when the legs are brought back to the retracted position. This automatic deployment mechanism ensures that the cross-support struts 120 always provide stability during use without requiring additional steps from the user.

### CONCLUSION

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the camera support apparatus of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A camera support apparatus, comprising:
a base assembly comprising a central hub and a plurality of leg members, each of the plurality of leg members being pivotably connected to the central hub and movable between a retracted position and an extended position, wherein in the extended position, the plurality of leg members form a stable support base for the apparatus, and in the retracted position, the plurality of leg members are aligned substantially parallel to one another;
a vertical support assembly extending upwardly from the base assembly, the vertical support assembly comprising a plurality of interconnected support sections, each support section being pivotably connected to an adjacent support section by a tensioned joint, wherein the tensioned joints permit selective angular adjustment of the support sections relative to one another and are configured to maintain a set angular position without the need for manual locking;
a top handle assembly coupled to an uppermost support section of the vertical support assembly, the top handle assembly comprising a camera mount configured to receive and secure a camera, wherein the top handle assembly is configured to permit manual adjustment of the orientation of the camera mount;
wherein the base assembly, vertical support assembly, and top handle assembly are arranged such that the camera support apparatus is foldable into a compact configuration by pivoting the leg members of the base assembly to the retracted position and pivoting the support sections of the vertical support assembly into alignment with one another.

2. The camera support apparatus of claim 1, wherein the central hub of the base assembly further comprises a sliding mechanism configured to allow linear movement of the central hub along a central axis, wherein the linear movement causes the plurality of leg members to transition between the retracted position and the extended position.

3. The camera support apparatus of claim 2, wherein each of the plurality of leg members includes a locking mechanism configured to secure the leg members in the extended position to prevent unintentional movement during use.

4. The camera support apparatus of claim 3, wherein each of the plurality of leg members further comprises a vibration-damping foot assembly at a distal end, the vibration-damping foot assembly comprising a hard plastic foot portion configured to reduce vibrations transmitted from a surface to the apparatus.

5. The camera support apparatus of claim 1, wherein the tensioned joints of the vertical support assembly are configured as knobless joints that automatically maintain the angular position of the interconnected support sections through internal tension without the need for external locking components.

6. The camera support apparatus of claim 5, wherein each of the tensioned joints comprises a flexing mechanism, the flexing mechanism being configured to allow smooth and incremental angular adjustment of the support sections while providing resistance to prevent inadvertent changes in angular position.

7. The camera support apparatus of claim 1, wherein the vertical support assembly is configured to fold such that each support section aligns substantially parallel to one another when in the compact configuration, and wherein the length of the vertical support assembly in the folded state is minimized for portability.

8. The camera support apparatus of claim 1, wherein the top handle assembly further comprises a rotational mechanism configured to allow the camera mount to rotate about a vertical axis relative to the uppermost support section, permitting panoramic rotation of the camera.

9. The camera support apparatus of claim 1, wherein the camera mount comprises a standard ¼″-20 tripod screw configured with a large knob for manual tightening, allowing secure attachment of the camera to the top handle assembly.

10. The camera support apparatus of claim 9, wherein the camera mount further includes an integrated quick-release mechanism, the quick-release mechanism configured to allow rapid attachment and detachment of the camera from the camera mount without the need for manual threading.

11. The camera support apparatus of claim 1, wherein the base assembly further comprises a cross-support strut assembly, the cross-support strut assembly connecting the leg members to provide additional stability when the leg members are in the extended position.

12. The camera support apparatus of claim 11, wherein the cross-support strut assembly is configured to automatically deploy as the leg members are moved to the extended position and automatically retract when the leg members are moved to the retracted position.

13. The camera support apparatus of claim 1, wherein the vertical support assembly has an adjustable height, with a minimum height of approximately 56 cm and a maximum height of approximately 158 cm.

14. The camera support apparatus of claim 1, wherein the entire apparatus is constructed from aluminum for lightweight strength and durability, with select components made from hard plastic for vibration damping and user comfort.
